(19) United States
(12) Patent Application Publication
(10) Pub. No.: US 2016/0125318 A1
(43) Pub. Date: May 5, 2016

(54) User-Assisted Learning in Security/Safety Monitoring System

(71) Applicant: Canary Connect, Inc., New York, NY (US)

(72) Inventors: Marc P. Scoffier, Brooklyn, NY (US); Jonathan D. Troutman, Brooklyn, NY (US); Timothy Robert Hoover, Brooklyn, NY (US); Sheridan Kates, New York, NY (US); Adam D. Sager, Englewood Cliffs, NJ (US); Christopher I. Rill, Mamaroneck, NY (US); Mayank Rana, Jersey City, NJ (US)

(21) Appl. No.: 14/930,039

(22) Filed: Nov. 2, 2015

Related U.S. Application Data
(60) Provisional application No. 62/074,231, filed on Nov. 3, 2014.

(51) Int. Cl. G06N 99/00; G08B 29/20

(52) U.S. Cl. CPC G06N 99/005; G08B 29/20

(57) ABSTRACT

A method includes: collecting data about a first event at a first physical space using a first electronic monitoring device that is physically located at the first physical space, enabling the collected data to be displayed at a computer-based user interface device (e.g., at a user's a smartphone that may be remotely located relative to the first electronic monitoring device), enabling the user to describe, using the computer-based user interface device, the first event represented by the collected data, and storing, in a computer-based memory, a logical association between the user's description of the first event and one or more characteristics of the collected data.

### CROSS-REFERENCE TO RELATED APPLICATION(S)

This application claims the benefit of priority to U.S. Provisional Patent Application No. 62/074,231, entitled, User-Assisted Learning in Security/Safety Monitoring System, which was filed on Nov. 3, 2014. The disclosure of the prior application is incorporated by reference herein in its entirety.

### FIELD OF THE INVENTION

This application relates to security and/or safety monitoring and, more particularly, relates to user-assisted learning in a security/safety monitoring system.

### BACKGROUND

Some traditional home security systems use sensors mounted on doors and windows. These systems can sound an alarm and some even include remote monitoring for sounded alarms. These systems, however, fall short on intelligence and interactive functionalities, as well as adaptability. False alarms can be common.

### SUMMARY OF THE INVENTION

In one aspect, a method includes: collecting data about a first event at a first physical space using a first electronic monitoring device that is physically located at the first physical space, enabling the collected data to be displayed at a computer-based user interface device (e.g., at a user's a smartphone that may be remotely located relative to the first electronic monitoring device), enabling the user to describe, using the computer-based user interface device, the first event represented by the collected data, and storing, in a computer-based memory, a logical association between the user's description of the first event and one or more characteristics of the collected data.

In a typical implementation, the method further includes collecting data about a second event at the first physical space using the first electronic monitoring device, and determining (e.g., with a computer-based processor within or external to the first electronic monitoring device) if the data collected about the second event is similar (e.g., it surpasses some minimal threshold criteria for similarity) to the data collected about the first event.

In some implementations, if the processor determines that the data collected about the second event is similar to the data collected about the first event, then the system may tailor a response to the second event in view of the user's description of the first event. Possible responses can include: contacting the user (e.g., via a push notification, a text, an email or a phone call that can be retrieved from the user's smartphone, for example), contacting user-designated back-up contacts using similar means, contacting the police department, the fire department, emergency medical personnel, do nothing at all, etc. In one example, tailoring the response to the second event includes: including a user-directed message with a user communication about the second event utilizing information from the user's description of the first event.

In some implementations, determining if the data collected about the second event is similar to the data collected about the first event involves applying one or more metric learning or similarity learning techniques.

The method can also include: collecting data about a second event at a second physical space (different than the first) using a second electronic monitoring device; and determining if the data collected about the second event at the second physical space is similar to the data collected about the first event at the first physical space. Typically, if the data collected about the second event at the second physical space is determined to be similar to the data collected about the first event at the first physical space, then tailoring the response to the second event at the second physical space is done in view of the user's description of the first event at the first physical space.

In a typical implementation, each electronic monitoring device (e.g., the first and the second) has a video camera and the collected data includes a video clip of the physical space (i.e., the space being monitored). Moreover, in a typical implementation, the collected data to be displayed at the computer-based user interface device may include a version of the video clip that can be played on the computer-based user interface device.

In some implementations, enabling a user to describe the first event represented by the collected data includes prompting the user to identify, using his or her computer-based user interface device, one or more elements (e.g., a person, a pet, a television screen, etc.) contained in the video clip. Sometimes, prompting the user to identify what is shown in the video clip includes: providing, at the computer-based user interface device, a list of items, from which the user can select one or more that the video clip contains, and/or enabling the user to enter a written description of what the video clip contains. The list of items may be accessible by selecting a button presented at the computer-based user interface device in association with the video clip. Moreover, the collected data may include non-video data (e.g., temperature data, location of different users, etc.).

A variety of characteristics may be represented by the collected data. Some of these include motion, object size, object shape, speed and acceleration.

The collected data is generally relevant to security or safety in the physical space.

In a typical implementation, the user owns or resides at (or works at) the monitored physical space. Other users (e.g., backup users) may use the system as well.

In another aspect, a system includes: a first monitoring device physically located in a first physical space, a security processing system coupled to the first monitoring device via a computer-based network (e.g., the Internet), and a computer-based user interface device (e.g., a smartphone, etc.) coupled, via the computer-based network, to the security/safety monitoring device.

In a typical implementation, the system is configured to: collect data about a first event at a physical space using the first monitoring device that is physically located at the first physical space, enable the collected data to be displayed at the computer-based user interface device, enable a user to describe, using the computer-based user interface device, the first event represented by the collected data, and store, in a computer-based memory, a logical association between the user's description of the first event and one or more characteristics of the collected data.

In yet another aspect, a non-transitory, computer-readable medium is disclosed that stores instructions executable by a processor to perform the steps of the methodologies disclosed herein.

In some implementations, one or more of the following advantages are present.

For example, the systems and functionalities disclosed herein facilitate automatic, intelligent, management of potential security issues that may arise in a monitored space (e.g., a person's home or the like). Moreover, the system can evolve over time to better understand the monitored environment, the people and activities typically within the monitored environment, habits, routines, etc. Home owners are able to “teach” the system what matters (from a security and safety perspective) and what does not matter (from a security and safety perspective). Generally speaking, the more the system is used, the better it becomes at enhancing the user's security.

Other features and advantages will be apparent from the description and drawings, and from the claims.

### BRIEF DESCRIPTION OF DRAWINGS

FIG. 1 is a schematic representation of an exemplary security/safety monitoring system.

FIG. 2 is a flowchart of an exemplary technique that may be implemented by the system in FIG. 1.

FIG. 3 shows an exemplary screenshot with a message that might appear, for example, at one of the computer-based user interface devices in the system of FIG. 1.

FIGS. 4A-4C show three exemplary screenshots with options for a user to identify what video clips acquired by the system in FIG. 1 contain.

FIGS. 5A and 5B show a sequence of exemplary screenshots that may be viewable at one of the computer-based user interface devices in the system of FIG. 1.

FIG. 6 shows an exemplary screenshot that might appear at one of the user-interface devices in the system of FIG. 1.

FIG. 7 is a perspective view of an exemplary security/safety monitoring device.

FIG. 8 is a schematic representation showing one example of the internal components in a particular implementation of an exemplary security/safety monitoring device.

FIG. 9 is a schematic representation of another exemplary security/safety monitoring system.

FIG. 10 shows an exemplary screenshot with a message that might appear, for example, at one of the computer-based user interface devices in the system of FIG. 1.

Like reference numerals refer to like elements.

### DETAILED DESCRIPTION

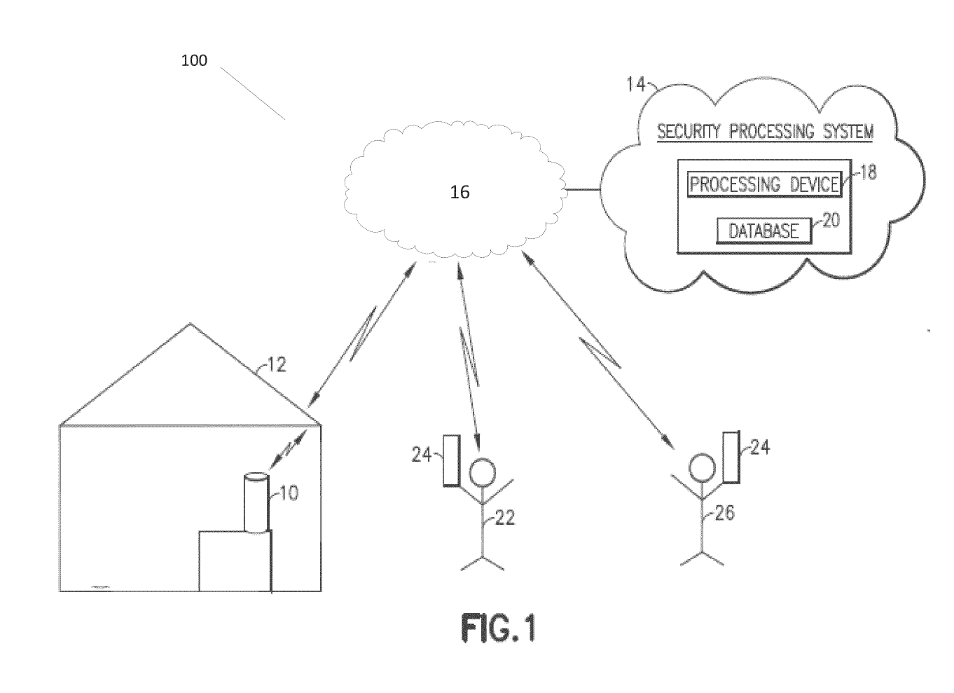

FIG. 1 is a schematic representation of an exemplary security/safety monitoring system 100 adapted to implement certain aspects of the functionalities disclosed herein.

The illustrated system 100 includes a security/safety monitoring device 10. The monitoring device 10 is inside a house 12 and is positioned to monitor various environmental characteristics of a particular physical space inside the house. A remotely-located, computer-based processing system 14 is coupled to the monitoring device 10 via a computer-based network (e.g., the Internet 16) and computer-based user interface devices 24 (e.g., smartphones belonging to different people 22, 26 who live at the house 12) are coupled to the computer-based processing system 14 via the computer-based network 16. In general, the monitoring device 10, the computer-based processing system 14 and the user interface devices 24 are able to communicate with each other over the computer-based network 16.

The computer-based processing system 14 includes a computer-based processor 18 and a computer-based memory device for storing a database 20.

Each computer-based user interface device 24 provides a platform upon which the different users can interact with the system 100. In some implementations, the interactions are conducted via a web portal (e.g., a website) and one or more email accounts, or text numbers accessible by the users from their devices 24. In other implementations, the interactions are conducted via an app (i.e., a software application downloaded onto one or more of the devices). In some implementations, the system may facilitate a combination of these, and other, platforms upon which interactions may occur.

The interface may be configured to appear at a user's device in any one of a variety of possible configurations and include a wide variety of different information. For example, in some implementations, the interface may provide for system messaging (e.g., notifications, etc.). It may enable the users to access data about a monitored space (e.g., view videos, and see other data, etc.). The interface may be configured to present a timeline for each user that includes a time line of data (e.g., videos, etc.) captured and organized in a temporal manner. Other variations are possible as well.

In general, the illustrated system 100 is operable to monitor the physical space inside the house 12 from a security and/or safety perspective. Part of this monitoring functionality is performed by a video camera in the monitoring device 10 that is configured to acquire one or more video clips of the monitored space. The acquired video clip(s) can be a continuous stream of video or can be discrete segments of video.

In a typical implementation, anytime the monitoring device 10 is on or powered-up, the video camera is acquiring video. However, in other implementations, the video camera can be configured to acquire discrete segments of video only, for example, in response to a trigger of some sort (e.g., when motion or some other environmental parameter is detected in the monitored space).

In a typical implementation, the monitoring device 10 is configured to acquire other types of data (beyond video) about the monitored space. For example, in a typical implementation, the monitoring device 10 is configured to acquire one or more of temperature data, air quality data, humidity data, audio data, ambient light data, movement data, etc. from the monitored space.

In general, the monitoring device 10 is operable to transmit data it acquires, including video, to the remote security processing system 14. In some implementations, the monitoring device 10 transmits all of the data it acquires to the remote security processing system 14. This may be done on a continual or periodic basis. In some implementations, the monitoring device 10 transmits less than all of the data it acquires to the remote security processing system 14. For example, in some implementations, to ensure the efficient use of bandwidth, the monitoring device 10 performs some preliminary processing of the video data (and/or other data) it acquires to determine whether the acquired data (or particular segments of the acquired data) are likely relevant to safety and/or security in the monitored space and, therefore, should be sent to the security processing system 14 for additional processing and/or communication to one or more of the user interface devices 24. If the monitoring device 10 determines that the acquired data is likely not relevant, then the acquired data may not be transmitted to the remote processing system 14 and may, instead, simply be discarded. If the monitoring device 10 determines that the acquired data is likely relevant, then the acquired data may be transmitted to the remote processing system 14.

In a typical implementation, the system 100 is operable as follows. First, the monitoring device 10 acquires data about the monitored space, including one or more video clips of the monitored space. At least some of the acquired data is transmitted to the security processing system 14. The security processing system 14 enables the collected data to be displayed at one or more of the user interface devices 24. The security processing system 14 also enables any users (e.g., 22 or 26) who access the displayed data to enter information from his or her user interface devices 24 describing whatever event might be represented by the collected data. In a typical implementation, the user is able to describe the event after he or she views a video clip of, and any other data collected about, the event. The security processing system 14 then creates and stores (e.g., in the database 20 of its computer-based memory) a logical association between the user's description of the event represented by the collected data and one or more characteristics of the collected data.

In a typical implementation, the system 100 creates and stores any logical associations each time a user associated with the space provides a description of an event. Each time a new logical association is created, the system 100 learns more about the monitored space and what certain collections of characteristics in a video clip and other collected data might represent in terms of real world events. In some implementations, the system 100 learns over time about the environment and events that happen in the environment by applying one or more metric learning or similarity learning techniques. Moreover, the metric learning or similarity learning techniques can be applied on a pixel basis.

In a typical implementation, each time the system 100 acquires new data (e.g., a new video clip and/or other data about an event in the monitored space), it considers whether the new data has characteristics that are similar to the data characteristics associated with a previous event (e.g., one that a user has previously described and is, therefore, the subject of a logical association in the system). If so, the system 100 automatically tailors its response to the new data in view of the event description provided by a user that corresponds to the similar logical association.

For example, if a user has described one event (represented, for example, by data that includes a video clip of the monitored space) as containing pet movement (e.g., a dog walking across the floor), the system 100 creates a logical association between characteristics of the data (e.g., the video clip) and pet movement. In this example, if the system 100 subsequently (e.g., the next day) acquires new data that is similar to the data that the user previously described as representing pet movement, then the system 100 may determine that the new data also represents pet movement.

Once the system 100 determines if the newly acquired data is similar to previously described data, it can tailor its response accordingly. So, if the newly acquired data is determined to be similar to data that previously was described by a user as pet movement, the system 100 may inform one or more users that pet movement has been detected in the monitored space. Alternatively, the system 100 may decide to not inform any users at all about data that is determined to represent pet movement. The specific actions that the system 100 takes in different situations can be automatic or can be in view of instructions provided by the users themselves or can be dependent on the particular operating mode the system is in.

Thus, the user's feedback (i.e., descriptions of events) help the system 100 learn about the environment it is monitoring so that it can become more and more intelligent about its monitoring and alerting functionalities over time.

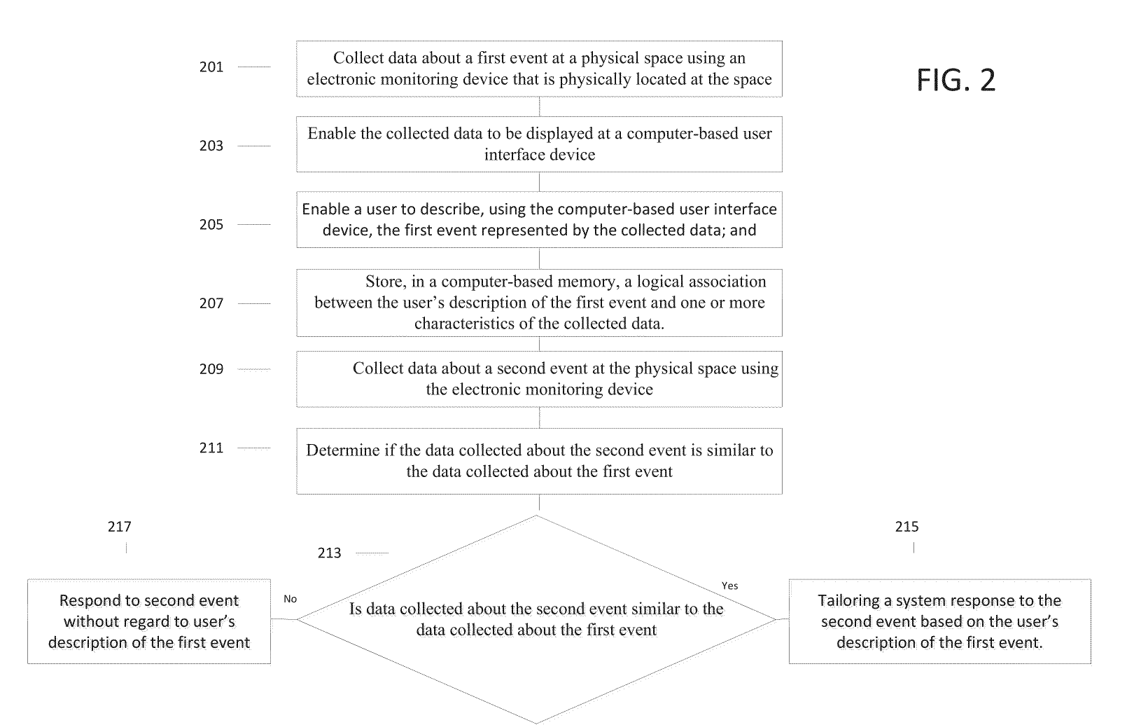

A detailed example of the techniques that may be implemented by the system 100 in FIG. 1 is represented by the flowchart in FIG. 2.

According to the exemplary method in FIG. 2, the system 100 (at 201) collects data about a first event at a monitored physical space (e.g., a person's apartment) using an electronic monitoring device (e.g., 10 in FIG. 1) located in monitored space. As already mentioned, the data that is collected in this regard, can include video data (e.g., one or more video clips) and/or other environmental data, such as temperature, humidity, ambient light, sound, etc.

The system 100 then (at 203) enables the collected data to be displayed at one or more computer-based user interface devices (e.g., 24 in FIG. 1). The computer-based user-interface devices can be any kind of computer-based device, at which a user can access data, such as video data and other environmental data. In one example, one or more of the computer-based device are smartphones. In general, the term smartphone should be construed broadly and to include any kind of cellular phone that performs functions of a computer and typically has a touchscreen interface, Internet access, and an operating system capable of running downloaded applications. In another example, one or more of the computer-based devices are laptop or desktop computers.

The system 100 can enable the collected data to be displayed (e.g., presented) at the computer-based user interface devices in a number of possible ways including, for example, by pushing, emailing, text messaging, posting to a user-accessible website, delivering a message via an application, etc. a message that includes the collected data. In one example, the message may include an embedded video that the user can play by interacting with control features on the touchscreen of his or her smartphone.

In some implementations, the system 100 displays all (or substantially all) of the data collected by the monitoring device at the user-interface device(s). However, more typically, the system 100 filters out some of the data. In one exemplary implementation, the monitoring device determines whether a particular data set (e.g., a 30 second video clip) is likely to be of interest to a user from a safety or security perspective. Only those data sets that are deemed of interest are sent to the security processing system 14 for further processing and possible display on the user-interface device(s).

Typically, the message with the collected data that is presented at the user interface device(s) includes a textual description of what the system 100 understands the collected data to represent. So, if the system 100 was not able to determine any particular information about the collected data, the textual description will likely be rather generic (e.g., “activity detected at home”). However, if the system 100 was able to determine particular information about the collected data (e.g., that the collected data, i.e., video clip, likely shows people in the monitored space), then the textual message delivered with the collected data can be much more specific (e.g., “people detected at home”).

Referring again to FIG. 2, the illustrated method includes (at 205) enabling a user to describe the first event. In a typical implementation, the user is able to describe the event after viewing the collected data (e.g., a video clip showing the first event).

There are a variety of ways that the system 100 might enable the user to describe the first event. According to one example, the system 100 presents to the user a user-selectable button, the selection of which enables the user to enter descriptive information about what he or she has seen in the video clip. In this example, selecting the user-selectable button causes the system 100 to present to the user a list of user-selectable things that the video clip might possibly contain. The list might identify, for example, people, pet movement, sunlight shadows, reflections, a television screen, a computer screen, a moving fan, motion outside of the monitored space, etc. The user's selection of any of the listed things is treated by the system 100 as an indication that the video clip in question includes the selected thing. So, if the user selects the “pet movement” option, the system 100 will assume that the video clip in question includes pet movement.

In some implementations, the system 100 also presents to the user an “other” option, the selection of which indicates that video clip in question contains something other than the specific listed options. If the user selects the “other” option, he or she may be prompted by the system 100 to describe, in his or her own words, what the video clip contains.

Referring again to FIG. 2, after the user describes the first event (e.g., that the video clip corresponding to the first event contains “pet movement”), the system 100 (at 207) creates a logical association between the user's description (i.e., “pet movement”) and one or more characteristics of the collected data (e.g., one or more characteristics of the video clip).

If, for example, the video clip in question (of the first event) showed a small brown dog running across a room being monitored by the electronic monitoring device, the system 100 (e.g., the security processing system 14 in FIG. 1) might identify one or more characteristics of the video clip. The one or more characteristics can include any characteristics that might be helpful to uniquely identify a particular event. In the dog running across the room example, the characteristics might include, for example, that motion occurs only in the lower half of the video clip, that an apparent approximate speed is associated with the motion, and that the motion is performed by an object having an approximate size and shape, as evidenced by the visual data in the video clip.

If, in this example, the user describes the video clip as containing “pet movement,” then the system 100 creates a logical association between the user's description (i.e., “pet movement”) and the characteristics of the video clip (i.e., that motion occurs only in the lower half of the video clip, that an apparent approximate speed is associated with the motion, and that the motion is performed by an object having an approximate size and shape, as evidenced by the visual data in the video clip).

In a typical implementation, the system 100 stores the logical association in a computer-based memory (e.g., in the database 20 of the security processing system 14).

Next, according to the illustrated example, the system 100 (at 209) collects data (e.g., another video clip) about a second, subsequent event at the monitored physical space. For purposes of illustration, let us assume that the second, subsequent event also includes the small brown dog running across the room.

In the illustrated example, the system 100 (e.g., the security processing system 14) (at 211) determines whether the data collected about the second event (e.g., the second video clip) is sufficiently similar to the data collected about the first event (e.g., the first video clip). There are a number of ways that the system 100 may accomplish this. And, in a typical implementation, the collected data from the second event need not be identical, only sufficiently similar, to the collected data from the first event in order for the system 100 to consider them sufficiently similar. Sufficient similarity will generally depend on each specific situation.

However, in the dog running across the room example, the system 100 might determine that the data collected about the second event is similar to the data collected about the first event, particularly if they both have motion occurring only in the lower half of the video clip, show the object in motion having about the same approximate speed, and show that the object in motion has about the same approximate size and shape, as evidenced by the visual data in the video clip.

In some implementations, the system 100 assesses similarity by using one or more supervised machine learning techniques, such as, metric learning and/or similarity learning.

Similarity learning is an area of supervised machine learning that is closely related to regression and classification, but the goal is generally to learn from examples a similarity function that measures how similar or related two objects are. Similarity learning can include, for example, regression similarity learning, classification similarity learning and/or ranking similarity learning.

Similarity learning is closely related to metric learning. In general, metric learning refers to the task of learning a distance function over objects. Generally speaking, a distance function is a function that defines a distance between elements of a set.

In some implementations, the metric learning and/or similarity learning techniques are applied on a pixel basis. The term pixel refers generally to any of the small discrete elements that together constitute an image or a portion of a video clip.

If the system 100 (at 211) determines that the data collected about the second event (i.e., the second video clip) is sufficiently similar to the data collected about first event, then the system 100 (at 213) tailors its response to the second event according to any descriptions that a user might have provided about the first event. To continue with the example we've been discussing, if the system determines that the second video clip is substantially similar to the first video clip, which the user described as containing “pet movement,” then the system 100 (at 213 in FIG. 2) might tailor its response to the second event by providing a message to the user, along with the second video clip, that “pet movement has been detected at home,” instead of the more generic, “activity has been detected at home.”

In another example of tailoring its response, the system 100 (at 213 in FIG. 2) might tailor its response to the second event by recognizing that “pet movement” is either not worth informing any users about or is something that users have indicated they don't want to be informed of. In those instances, the system 100 may opt to not inform the user(s) of the second event, when it has been determined that it most likely only contains pet movement.

In the foregoing rather simple example, the user, by providing feedback about the video of the first event, essentially taught the system 100 to recognize at least some instances of a “pet movement” events and the system was able to adapt its behavior accordingly.

If (at 211 in FIG. 2), the system 100 determines that the data collected about the second event is not sufficiently similar to the data collected about the first event, then the system 100 responds (at 215) to the second event without regard to the user's description of the first event.

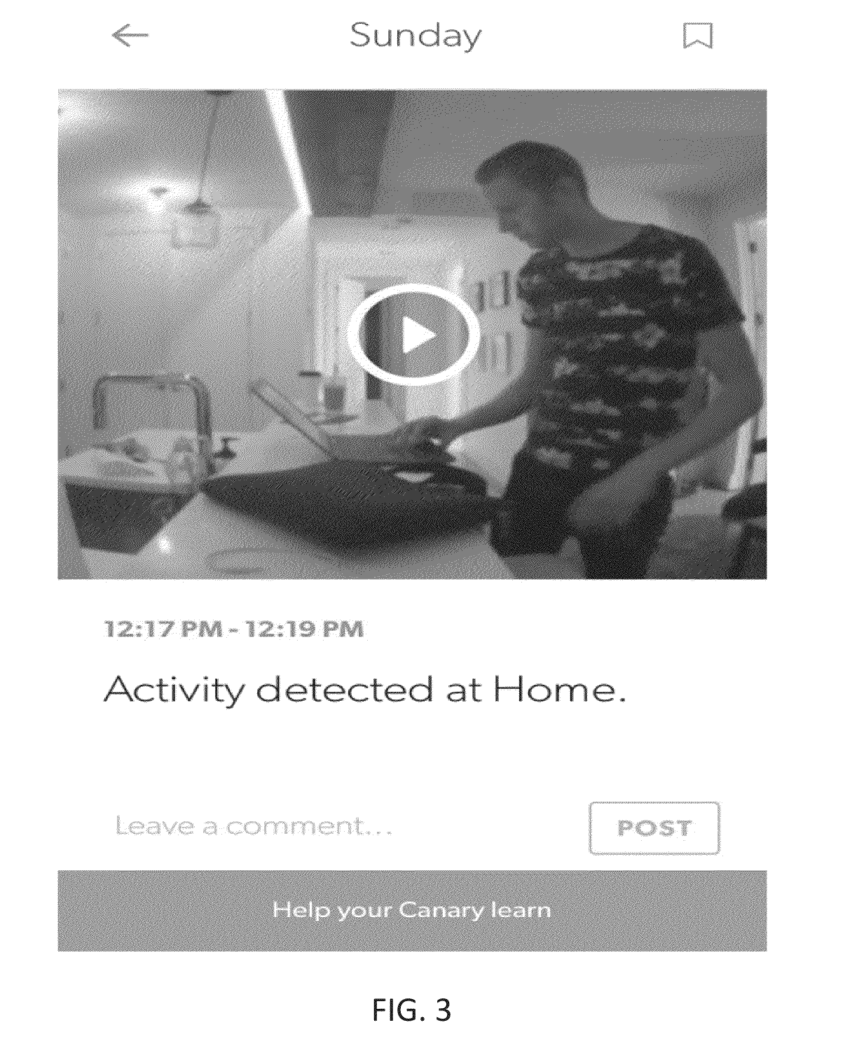

FIG. 3 shows an exemplary screenshot with a message that might appear, for example, at one of the computer-based user interface devices 24 in the system 100 of FIG. 1, enabling data (e.g., a video clip) collected from a monitored space to be displayed to a user. In the illustrated example, the message includes a two-minute long video clip (that was recorded on Sunday from 12:17 PM to 12:19 PM) that can be played by touching the touchscreen of the user's smartphone. The message indicates, rather generically, “Activity detected at home.”

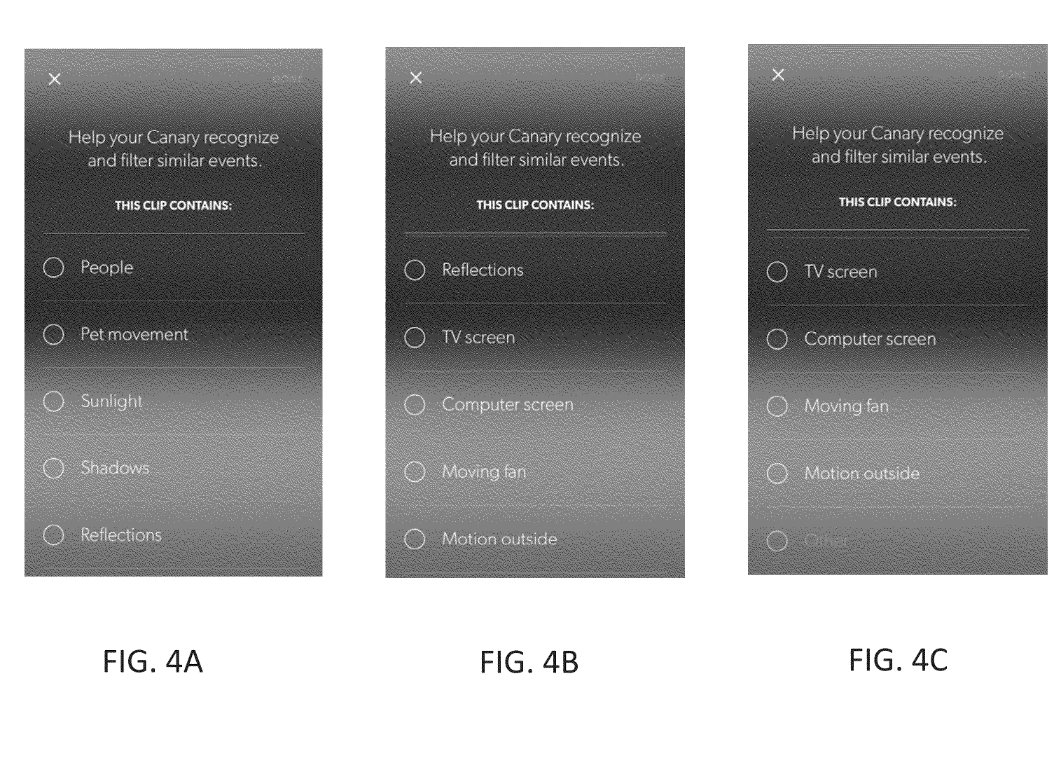

The illustrated screenshot includes a user-selectable button, with the message, “Help your Canary learn,” whereby Canary refers to the monitoring device/system (e.g., as shown in FIG. 1). In a typical implementation, selecting the user-selectable button causes the system 100 to present a new screenshot at the user-interface device 24 asking the user to identify what the video clip contains. Three examples of these screenshots, asking the user to identify what the video clip contains, are shown in FIGS. 4A-4C. Each of these screens includes a message to “Help your Canary [i.e., your monitoring device/system] recognize and filter similar events” and a listing of possible things that the video clip might contain.

In the example shown in FIG. 4A, the list includes: people, pet movement, sunlight, shadows and reflections. In the example shown in FIG. 4B, the list includes: reflections, TV screen, computer screen, moving fan, and motion outside. In the example shown in FIG. 4C, the list includes: TV screen, computer screen moving fan, motion outside and other. Of course, other list items and combinations of list items are possible. For example, in one other exemplary implementation, the list includes, people, pet movement, sunlight, shadows, reflections, television screen, computer screen, moving fan, motion outside. In some implementations, the system also may include the first names, of each of the users in that location (e.g., the first names of the people that the system understands reside at the monitored location).

In a typical implementation, a user, reviewing one of the screens shown in FIGS. 4A-4C can select one or more of the options listed and, when finished, select “done,” which appears in the upper right hand corner of the illustrated screenshots. This essentially submits the user's choices to the system 100 for processing. In some implementations, the system enables the user to enter any kind of written description that the user wants to provide, without being limited to only a list of options.

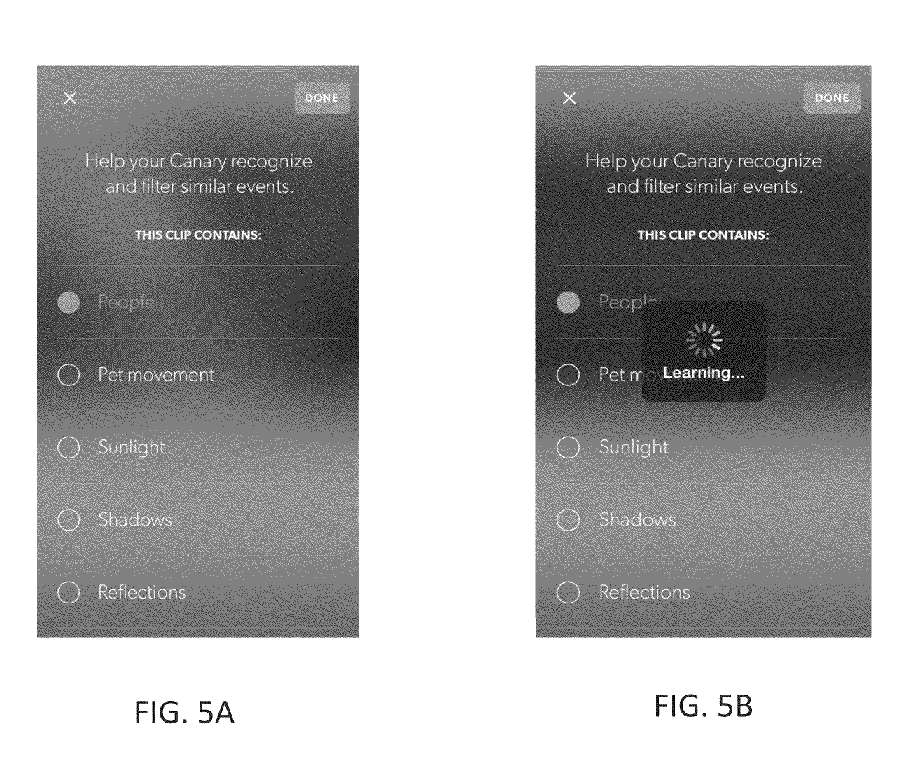

FIGS. 5A and 5B show a sequence of exemplary screenshots, whereby a user selects “People” from the illustrated list (in FIG. 5A) and then hits done (just before FIG. 5B).

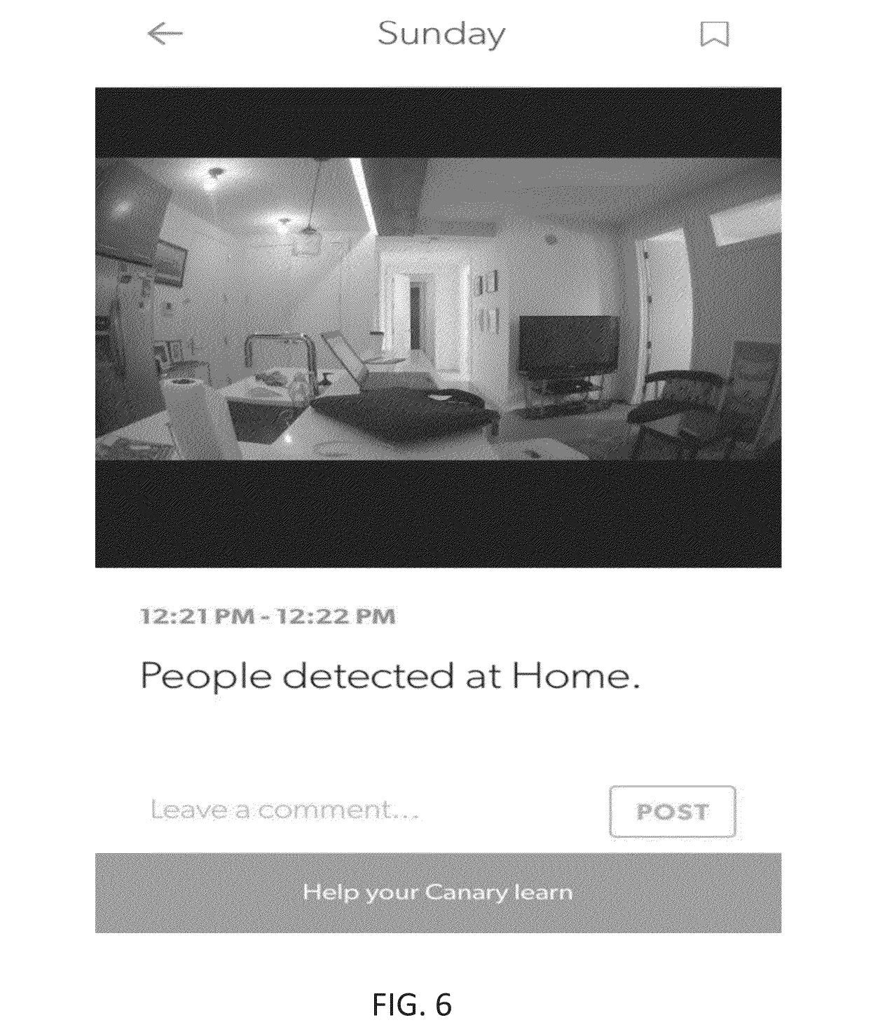

FIG. 6 shows an exemplary screenshot that might appear at one of the user-interface devices if the system 100 determines that a subsequent event (i.e., the one shown in the video clip in FIG. 6) is sufficiently similar to the previous event that the user described (in FIGS. 5A and 5B, for example) as “People.” In the screenshot of FIG. 6, the video clip is accompanied by the message, “People detected at home,” which can be much more helpful to the recipient than the more generic message in the screenshot of FIG. 3, “Activity detected at home.”

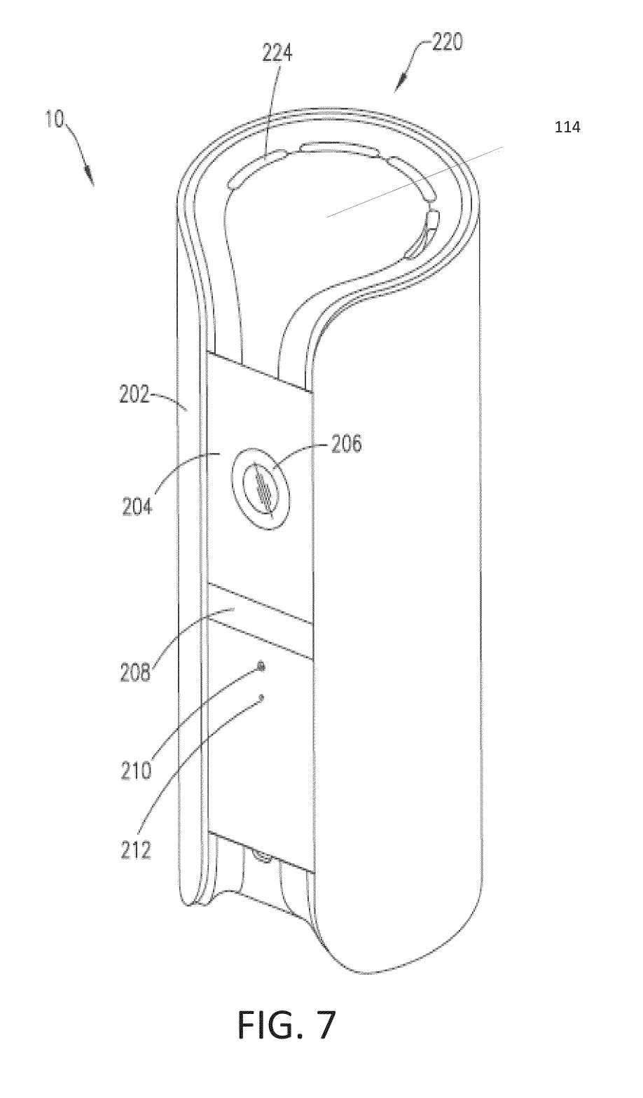

FIG. 7 is a perspective view of an exemplary security/safety monitoring device 10.

The illustrated device 10 has an outer housing 202 and a front plate 204. In this example, the front plate 204 defines a first window 206, which is in front of an image sensor (e.g., a video camera). A second window 208, which is rectangular in this example, is in front of an infrared LED array. An opening 210 is in front of an ambient light detector, and opening 212 is in front of a microphone. The front plate 204 may be a black acrylic plastic, for example. The black plastic acrylic plastic in some implementations is transparent to near IR greater than 800 nm.

The top 220 of the device 10 is also shown. The top 220 includes outlet vents 224 that allow for airflow out of the device 10. In a typical implementation, the bottom of the device includes inlet vents to allow airflow into the device 10. During operation, air passes through the bottom inlet vents, travels through the device 10, where it picks up heat from the internal components of the device, and exits through the top, outlet vents 224. In this example hot air rises through the device 10, causing air to be drawn into the device from the bottom vents and to exit out of the top vents 224. A fan may be provided to draw external air into the device 10 through the bottom, inlet vents and/or to drive the air out of the device through the top, outlet vents 224.

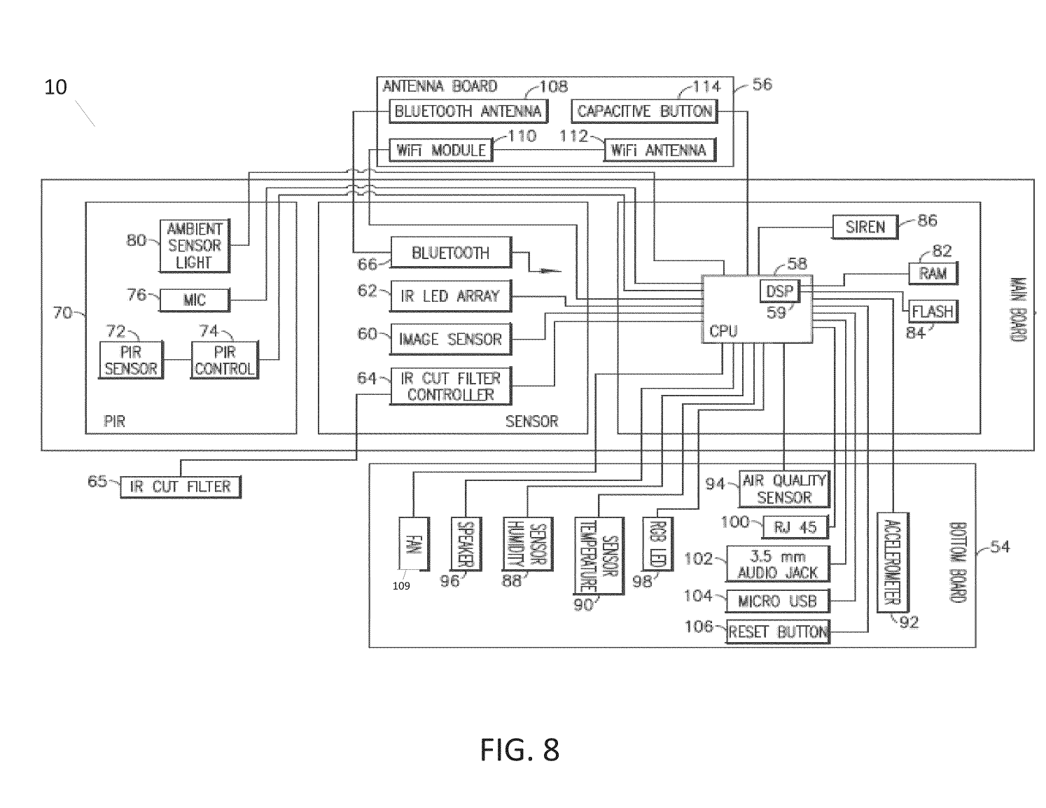

In a typical implementation, the device 10 shown in FIG. 7 includes circuitry, internal components and/or software to perform and/or facilitate the functionalities disclosed herein. An example of the internal components, etc. in one implementation of the device 10 is shown in FIG. 8.

In FIG. 8, the illustrated device 10 has a main printed circuit board (“PCB”), a bottom printed circuit board 54, and an antenna printed circuit board 56. A processing device 58 (e.g., a central processing unit (“CPU”)) is mounted to the main PCB. The processing device may include a digital signal processor (“DSP”) 59. The CPU 58 may be an Ambarella digital signal processor, A5x, available from Ambarella, Inc., Santa Clara, Calif., for example.

An image sensor 60 of a camera (e.g., capable of acquiring video), an infrared light emitting diode (“IR LED”) array 62, an IR cut filter control mechanism 64 (for an IR cut filter 65), and a Bluetooth chip 66 are mounted to a sensor portion of the main board, and provide input to and/or receive input from the processing device 58.

The main board also includes a passive IR (“PIR”) portion 70. Mounted to the passive IR portion 70 are a PIR sensor 72, a PIR controller 74, that may be a microcontroller, a microphone 76, and an ambient light sensor 80. Memory, such as random access memory (“RAM”) 82, and flash memory 84 are also mounted to the main board. A siren 86 is also mounted to the main board.

A humidity sensor 88, a temperature sensor 90 (which may be combined into a combined humidity/temperature sensor), an accelerometer 92, and an air quality sensor 94, are mounted to the bottom board 54. A speaker 96, a red/green/blue (“RGB”) LED 98, an RJ45 or other such Ethernet port 100, a 3.5 mm audio jack 102, a micro USB port 104, and a reset button 106 are also mounted to the bottom board 54. A fan 109 is also provided.

A Bluetooth antenna 108, a WiFi module 110, a WiFi antenna 112, and a capacitive button 114 are mounted to the antenna board 56.

The illustrated components may be mounted to different boards and configured generally differently than shown. For example, the Wifi module 110 may be mounted to the main board 52. In addition, in some implementations, some of the components illustrated in FIG. 8 may be omitted.

In general, the monitoring device 10 represented by FIG. 7 and FIG. 8 is operable to acquire data about the physical space where the monitoring device 10 is located and communicates (e.g., using the communications module(s) at 56 or other communications modules) with other system components to support and/or implement the functionalities disclosed herein. In some implementations, the processor 58 is configured to perform at least some of the processing described herein. In some implementations, the processing device 18 (at the remotely-located computer-based processing system 14) is configured to perform at least some of the processing described herein. In a typical implementation, processor 58 and processor 18 work in conjunction to perform the processing described herein.

Other exemplary monitoring devices and/or environments in which the systems, techniques and components described herein can be incorporated, deployed and/or implemented are disclosed in pending U.S. patent application Ser. No. 14/260,270, entitled Monitoring and Security Systems and Methods with Learning Capabilities, which is incorporated herein in its entirety.

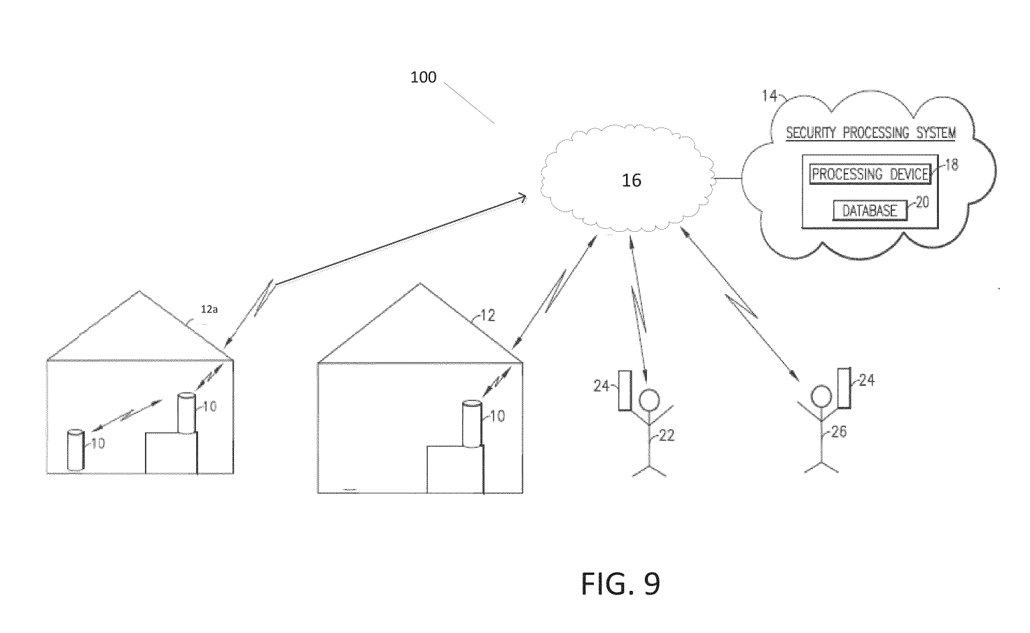

In some implementations, learning acquired from multiple system users, some of whom may be associated with different monitored locations, can be applied system-wide. FIG. 9 is a schematic representation of an exemplary system that can be used to illustrate this concept.

The system in FIG. 9 is similar to the system of FIG. 1, except the system in FIG. 9 has multiple monitoring devices 10, one in a first house 12 and two in a second house 12a. The two monitoring devices 10 in the second house 12a may be positioned to monitor different locations within that house 12a. For purposes of illustration, it should be assumed that user 22 lives in house 12 and user 26 lives in house 12a.

If, one of the system user (e.g., 22 in FIG. 9), who lives at a first location (e.g., 12 in FIG. 9) categorizes (describes) a particular video clip from his home as containing a dog, the system 100 may apply that learning to determine whether a dog is present in a video clip acquired from a second location (e.g., from one of the monitoring devices 10 in 12a in FIG. 9) where a different system user (e.g., 26 in FIG. 9) lives.

In a typical implementation, the system 100 determines if the video clip from the second location 12a is similar to the dog-containing video clip from the first location 12. If it is, then the system may tailor its response to the video clip from the second location 12a in view of the first user's 22 description of the dog-containing video clip. In some implementations, this may include specifically identifying to the second user 26 that a dog or pet movement has been detected in his or her home.

In some implementations, the system determines if the video clip from the second location is similar to the dog-containing video clip, at least in part, by applying one or more metric learning or similarity learning techniques.

So if, one of the system user (e.g., 22 in FIG. 9), who lives at the first location (e.g., 12 in FIG. 9) categorizes (describes) a particular video clip from his home on as containing a dog, and the system 100 determines that a dog is present in a subsequent video clip from a different second location (e.g., 12a), the system 100 may send a communication to a second user (e.g., 26), who lives at the second location (e.g., 12a in FIG. 9) specifically identifying that a dog (or a pet) has been detected in the second user's home. In this example, the system 100 has the ability to do this even if the second user (26) has not previously entered any descriptions into the system 100 indicating that a pet was present in an earlier video clip acquired from his/her home (12a).

A number of embodiments of the invention have been described. Nevertheless, it will be understood that various modifications may be made without departing from the spirit and scope of the invention.

For example, the screenshots shown herein can appear completely different. Moreover, the specific order and format of the various communications to users and among various system components can vary. The timing between actions can vary.

Moreover, in a typical implementation, a system will include multiple monitoring devices 10 at different physical locations. In some implementations, the learning that comes from one device (e.g., what “pet movement” looks like) may be used to help another device (either in the same home or in a different home) in the system learn what “pet movement” looks like as well.

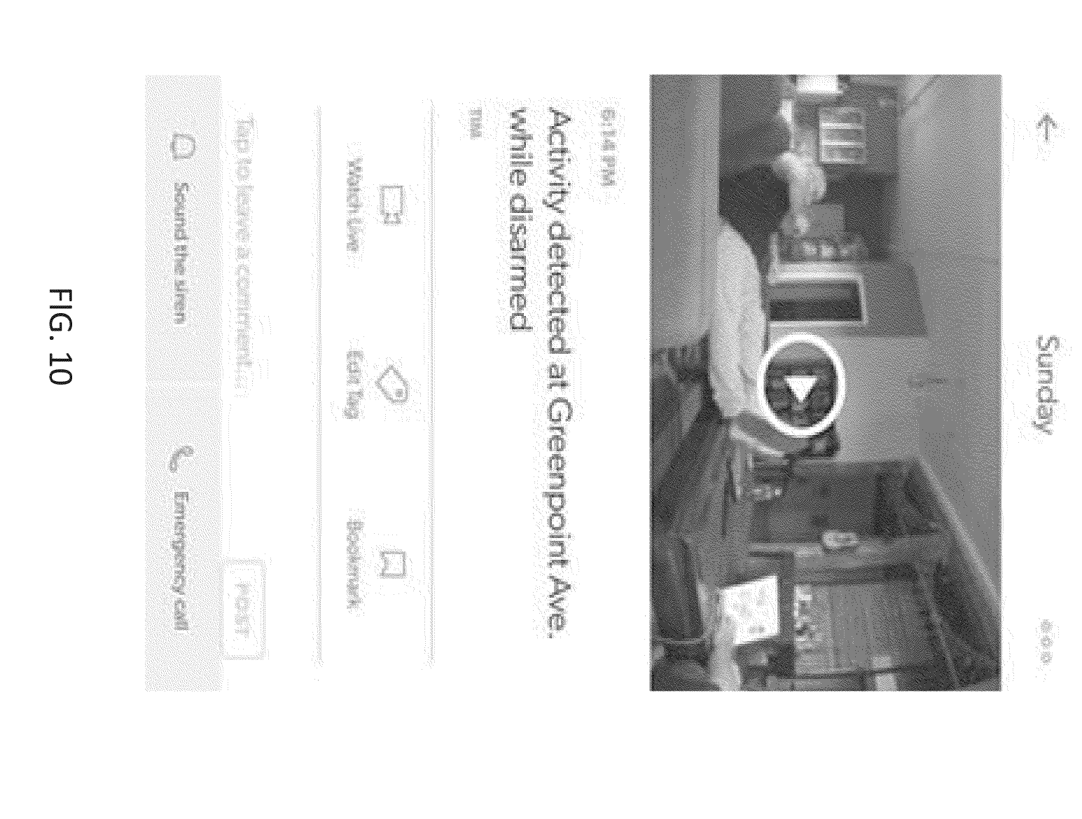

The screenshot in FIG. 3, for example, has a user-selectable button, with the message, “Help your Canary learn,” whereby Canary refers to the monitoring device/system (e.g., as shown in FIG. 1). As mentioned above, in a typical implementation, selecting that button causes the system 100 to present a new screenshot at the user-interface device 24 asking the user to identify what the video clip contains. Other techniques are possible to enable users to help the monitoring device/system “learn” about the environment(s) being monitored. According to one such example, the system may present a screen to a user (e.g., at the user's smartphone, etc.) that enables the user simply to tag a video. An example of this kind of screenshot is shown in FIG. 10.

The screenshot in FIG. 10 is similar in some ways to the screenshots in FIG. 3 and FIG. 6. However, the screenshot in FIG. 10 has three different links that are respectively labeled “Watch Live,” “Edit Tag,” and “Bookmark.” In a typical implementation, selecting the “Watch Live” link causes the system to present to the user (at his or her smartphone, for example) a video of the space being monitored live (or at least substantially live). In a typical implementation, selecting the “Bookmark” link causes the system to mark the corresponding video so that the corresponding video can be easily found at a later date. Moreover, in a typical implementation, selecting the “Edit Tag” link causes the system to enable the user to tag the video (e.g., specify who or what is in the video). In some implementations, selecting the “Edit Tag” link may call up similar screens (or facilitate similar functionalities) as shown, for example, in FIGS. 4A-4C, 5A and 5B. Essentially, by tagging the user can provide feedback for learning.

Once tagged, the system enables users to filter their videos by these tags. So, after tagging, a user can ask the system to show every saved video that includes a person or a pet or even a specific person. This encourages users to tag videos, and therefore increases the likelihood that videos will be tagged. Tagging helps the system, of course, learn more about a monitored environment which, in some instances, helps the system improve its ability to provide intelligent security and safety monitoring.

The screenshot in FIG. 10 also includes a “Sound the Siren” link, the selection of which by a user causes the system to sound an alarm (e.g., an alarm in the monitoring device 10 at the monitored location). A user may wish to do this if, for example, the video presented at the screen suggests or shows that something bad (e.g., a break-in or a fire) is happening at the monitored location.

The screenshot in FIG. 10 also includes an “Emergency Call” link. In a typical implementation, the system, in response to “Emergency Call” link being selected, causes the user's smart phone to automatically dial an emergency services provider (e.g., police department, fire department, hospital, etc.). Moreover, in a typical implementation, the emergency service provider whose number of automatically dialed is an emergency service provider located nearby the monitored location—not necessarily nearby the user who has selected the “Emergency Call” link.

Additionally, in some implementations, the system is configured to auto-populate the ‘first names’ of the user's from a specific monitored location (e.g., a home) into the list of possible tags. For instance, if Martin, Tim and Laurens all live in a specific home together and are all registered with the system as residents of the home, then the system may automatically present a list of possible tags for a video that list Martin, Tim, and Laurens as pre-populated labels.

In this example, the system may also recognize the labels Martin, Tim, and Laurens as a sub-set of the category ‘people’. The system, in some implementations, will learn over time what “Martin” looks like and auto tag certain videos to indicate, for example, “Martin detected at home.”

The techniques disclosed herein relate to very particular types of learning. However, in a typical implementation, the monitoring devices and/or other system components may also implement other types of machine learning techniques.

Moreover, once a video clip or a collection of video clips are described and/or categorized (e.g., as pet movement), the video clips may be saved (e.g., in a computer-based memory device). These saved video clips may then be searched using key words, such as “pet”—to identify, for viewing, any video clips the system has captured that show a pet.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

Computer-readable instructions to implement one or more of the techniques disclosed herein can be stored on a computer storage medium. Computer storage mediums (e.g., a non-transitory computer readable medium) can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” (e.g., a processor or the like) encompasses all kinds of apparatus, devices, and machines for processing data, including by way of example a programmable processor, a computer, a system on a chip, or multiple ones, or combinations, of the foregoing. Moreover, use of the term data processing apparatus should be construed to include multiple data processing apparatuses working together. Similarly, use of the term memory or memory device or the like should be construed to include multiple memory devices working together.

Computer programs (also known as programs, software, software applications, scripts, or codes) can be written in any form of programming language, including compiled or interpreted languages, declarative or procedural languages, and can be deployed in any form.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both.

A computer device adapted to implement or perform one or more of the functionalities described herein can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including, for example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented using a computer device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

This disclosure uses the terms “first” and “second,” for example, to refer to different instances of a similar thing. Except where otherwise indicated, these terms should be construed broadly. For example, the description refers to collecting data about a first event and a subsequent, second event first event at a monitored physical space. Of course, the subsequent, second event need not immediately follow the first event. For example, the first event may correspond to a 10^{th} video captured by the system and the subsequent, second event may correspond to a 25^{th} video captured by the system.

This description also mentions and the attached figures show a “Help your Canary [i.e., your monitoring device/system] recognize and filter similar events” accompanied by a listing of possible things that a particular video clip might contain. In some implementations, the system does not present a “Help your Canary recognize and filter similar events” button. Instead, the system will simply allow a user to “tag” an event with labels to define what a particular video clip contains. Indeed, there are a variety of ways the tagging functionality might be implemented.

The specific configuration of the monitoring device described herein can vary considerably. For example, in some implementations, as described herein, the monitoring device has passive infrared (PIR) sensing capabilities (e.g., with a main printed circuit board (“PCB”) that a passive IR (“PIR”) portion 70, with a PIR sensor 72 and a PIR controller 74. In some implementations, however, the monitoring device does not include PIR functionality. As such, the monitoring device according to those implementations would not include a passive IR (“PIR”) portion 70, with a PIR sensor 72 and a PIR controller 74. Many other variations of the monitoring device are possible as well.

In a typical implementation, the system 100 is able to be operated in any one of several different operating modes. For example, according to one implementation, the system 100 has three different operating modes: armed mode, in which the disarmed mode, and privacy mode.

In armed mode, the monitoring device 10 is powered on. Typically, in armed mode, the camera of the monitoring device is armed and enabled and the microphone of the monitoring device is armed and enabled. Moreover, the monitoring device 10 is looking for motion. In a typical implementation, upon detecting motion (or at least certain types of motion), the monitoring device starts uploading video data to the cloud service (e.g., security processing system 114) and sends push notification(s), or other communications, to one or more (or all) of the primary users, and/or backup contacts, associated with the monitored location where the motion has been detected with a call to action for those users to view the detected motion via the app or website. Any uploaded videos may be saved to a person's timeline.

In disarmed mode, the system acts in a manner very similar to the way the system acts in armed mode, one of the most notable differences being that, in disarmed mode, no notifications are sent to any of the users.

In privacy mode, the monitoring device 10 is powered on. However, it is generally not monitoring or recording any information about the space where it is located. In privacy mode, the camera is off and any listening devices (e.g., a microphone, etc.) are off; no video or audio is being recorded, and no users are really able to remotely view the space where the monitoring device 10 is located. Moreover, when the system 100 is in privacy mode, if a user accesses the system (e.g., through an app on their smartphone, or at a web-based portal), the “watch live” functionality that ordinarily would allow the user to see the monitored space is simply not available.

In a typical implementations, the operating modes may be controlled by a user through the software app and a user (e.g., a primary user associated with a monitored location) may switch the system between operating modes by interacting on the app. In a typical implementation, the functionalities disclosed herein are available in some of the operating modes (e.g., armed and disarmed). In some implementations, the functionalities disclosed herein may be available in all operating modes.

Other implementations are within the scope of the claims.

What is claimed is:

1. A method comprising:
collecting data about a first event at a first physical space using a first electronic monitoring device that is physically located at the first physical space;
enabling the collected data to be displayed at a computer-based user interface device;
enabling a user to describe, using the computer-based user interface device, the first event represented by the collected data; and
storing, in a computer-based memory, a logical association between the user's description of the first event and one or more characteristics of the collected data.

2. The method of claim 1 comprising:
collecting data about a second event at the first physical space using the first electronic monitoring device; and
determining if the data collected about the second event is similar to the data collected about the first event.

3. The method of claim 2, wherein if the data collected about the second event is determined to be similar to the data collected about the first event, then tailoring a response to the second event in view of the user's description of the first event.

4. The method of claim 3, wherein tailoring the response to the second event comprises: including a user-directed message with a user communication about the second event utilizing information from the user's description of the first event.

5. The method of claim 2, wherein determining if the data collected about the second event is similar to the data collected about the first event comprises applying one or more metric learning or similarity learning techniques.

6. The method of claim 1 comprising:
collecting data about a second event at a second physical space using a second electronic monitoring device; and
determining if the data collected about the second event at the second physical space is similar to the data collected about the first event at the first physical space,
wherein if the data collected about the second event at the second physical space is determined to be similar to the data collected about the first event at the first physical space, then tailoring a response to the second event at the second physical space in view of the user's description of the first event at the first physical space.

7. The method of claim 1, wherein the first electronic monitoring device comprises a video camera and the collected data comprises a video clip of the physical space.

8. The method of claim 7, wherein enabling the collected data to be displayed at the computer-based user interface device comprises presenting a version of the video clip at the computer-based user interface device.

9. The method of claim 7, wherein enabling a user to describe the first event represented by the collected data comprises:
prompting the user to identify, using the computer-based user interface device, one or more elements that the video clip contains.

10. The method of claim 9, wherein prompting the user to identify what is shown in the video clip comprises:
providing, at the computer-based user interface device, a list of items, from which the user can select one or more that the video clip contains, and/or
enabling the user to enter a written description of what the video clip contains.

11. The method of claim 10, wherein the list of items is accessible by selecting a button presented at the computer-based user interface device in association with the video clip.

12. The method of claim 7, wherein the collected data further comprises non-video data.

13. The method of claim 1, wherein each of the one or more characteristics of the collected data is a characteristic selected from the group consisting of: motion, object size, object shape, speed and acceleration.

14. The method of claim 1, wherein the collected data is relevant to security or safety in the physical space.

15. The method of claim 1, wherein the user owns or resides at the monitored physical space.

16. The method of claim 1, wherein the computer-based user interface device is a smartphone.

17. A system comprising:
a first monitoring device physically located in a first physical space;
a security processing system coupled to the first monitoring device via a computer-based network; and
a computer-based user interface device coupled, via the computer-based network, to the security/safety monitoring device,
wherein the system is configured to:
collect data about a first event at a physical space using the first monitoring device that is physically located at the first physical space;
enable the collected data to be displayed at the computer-based user interface device;
enable a user to describe, using the computer-based user interface device, the first event represented by the collected data; and
store, in a computer-based memory, a logical association between the user's description of the first event and one or more characteristics of the collected data.

18. The system of claim 17 wherein:
the first monitoring device is configured to collect data about a second event at the first physical space; and
the security processing system is configured to determine if the data collected about the second event is similar to the data collected about the first event.

19. The system of claim 18, wherein if the data collected about the second event is determined to be similar to the data collected about the first event, the security processing system tailors a response to the second event in view of the user's description of the first event.

20. The system of claim 19, wherein tailoring the response to the second event comprises: including a user-directed message with a user communication about the second event utilizing information from the user's description of the first event.

21. The system of claim 19, wherein determining if the data collected about the second event is similar to the data collected about the first event comprises applying one or more metric learning or similarity learning techniques.

22. The system of claim 17 further comprising:
a second electronic monitoring device at a second physical space,
wherein the system is configured to:
collect data about a second event at a second physical space using a second electronic monitoring device; and
determine if the data collected about the second event at the second physical space is similar to the data collected about the first event at the first physical space,
wherein if the data collected about the second event at the second physical space is determined to be similar to the data collected about the first event at the first physical space, then tailor a response to the second event at the second physical space in view of the user's description of the first event at the first physical space.

23. The system of claim 17, wherein the first electronic monitoring device comprises a video camera and the collected data comprises a video clip of the first physical space.

24. The system of claim 23, wherein enabling the collected data to be displayed at the computer-based user interface device comprises presenting a version of the video clip at the computer-based user interface device.

25. The system of claim 23, wherein enabling the user to describe the first event represented by the collected data comprises:
prompting the user, at the user-interface device, to identify one or more elements that the video clip contains.

26. The system of claim 25, wherein prompting the user to identify what is shown in the video clip comprises:
providing, at the computer-based user interface device, a list of items, from which the user can select one or more that the video clip contains, and/or
enabling the user to enter a written description of what the video clip contains.

27. The system of claim 26, wherein the list of items is accessible by selecting a button presented at the computer-based user interface device in association with the video clip.

28. The system of claim 23, wherein the collected data further comprises non-video data.

29. The system of claim 17, wherein each of the one or more characteristics of the collected data is a characteristic selected from the group consisting of: motion, object size, object shape, speed and acceleration.

30. The system of claim 17, wherein the collected data is relevant to security or safety in the physical space.

31. The system of claim 17, wherein the user owns or resides at the monitored first physical space.

32. The system of claim 17, wherein the computer-based user interface device is a smartphone.

33. A non-transitory, computer-readable medium that stores instructions executable by a processor to perform the steps comprising:
collecting data about a first event at a first physical space using a first electronic monitoring device that is physically located at the first physical space;
enabling the collected data to be displayed at a computer-based user interface device;
enabling a user to describe, using the computer-based user interface device, the first event represented by the collected data; and
storing, in a computer-based memory, a logical association between the user's description of the first event and one or more characteristics of the collected data.

34. The non-transitory, computer-readable medium of claim 33 storing instructions executable by a processor to further perform the steps comprising of:
collecting data about a second event at the first physical space using the first electronic monitoring device; and
determining if the data collected about the second event is similar to the data collected about the first event.

35. The non-transitory, computer-readable medium of claim 33 storing instructions executable by a processor to further perform the steps comprising of:
if the data collected about the second event is determined to be similar to the data collected about the first event, then tailoring a response to the second event in view of the user's description of the first event.

36. The non-transitory, computer-readable medium of claim 33, wherein determining if the data collected about the second event is similar to the data collected about the first event comprises applying one or more metric learning or similarity learning techniques.

37. The non-transitory, computer-readable medium of claim 33 that further stores instructions executable by the processor to perform the steps comprising:
collecting data about a second event at a second physical space using a second electronic monitoring device; and
determining if the data collected about the second event at the second physical space is similar to the data collected about the first event at the first physical space,
wherein if the data collected about the second event at the second physical space is determined to be similar to the data collected about the first event at the first physical space, then tailoring a response to the second event at the second physical space in view of the user's description of the first event at the first physical space.
